(19) United States
(12) Patent Application Publication
(10) Pub. No.: US 2014/0360823 A1
(43) Pub. Date: Dec. 11, 2014

(54) RAILWAY VEHICLE DISK BRAKE PAD

(71) Applicant: COFREN S.r.l, Avellino (IT)

(72) Inventor: Vittorio De Soccio, Benevento (IT)

(21) Appl. No.: 14/298,628

(22) Filed: Jun. 6, 2014

(30) Foreign Application Priority Data
Jun. 7, 2013 (IT) RM 2013A000334

(51) Int. Cl. B61H 5/00; F16D 65/092

(52) U.S. Cl. CPC B61H 5/00; F16D 65/092
USPC 188/250 G

(57) ABSTRACT

A railway vehicle disk brake pad having a base plate; a number of supporting plates fitted to the base plate; and a number of friction members fixed to the supporting plates. The base plate has a number of perforated drawing portions, each of which has a projection on which a respective supporting plate rests directly, thus forming a gap between the base plate and the supporting plate.

### CROSS-REFERENCE TO RELATED APPLICATIONS

This application claims priority to Italian Application No. RM 2013A000334, filed Jun. 7, 2013, the disclosure of which is incorporated herein by reference in its entirety.

### BACKGROUND OF THE INVENTION

The present invention relates to a railway vehicle disk brake pad.

As is known, disk brakes are subject to severe stress, and optimum braking depends on the braking force being transmitted effectively to the disk pad.

For some time now, the trend has been towards pads with a number of small friction members, as opposed to one large one. In one such solution, each pad comprises a main bearing plate; a number of supporting plates fixed to the main plate; and a number of friction members fixed individually or in pairs to respective supporting plates.

To ensure efficient cooling of the friction members, Patent DE10043528 describes and claims a solution whereby respective spacers are inserted between the supporting plates and the main plate to which they are fixed. The spacers form a gap between the supporting plates and the main plate, so as to ventilate and cool the friction members.

Each spacer has a centre hole which, on the assembled pad, is engaged by a rivet to secure the supporting plate to the main plate.

Though successful in ventilating the underside of the friction members, the spacers described and claimed in DE10043528 inevitably increase the number of component parts for assembly, thus increasing assembly time and the weight of the pad as a whole. The increase in the weight of the pad, in particular, increases wear on the seals and the noise level when braking.

A need is therefore felt for a solution by which to form a ventilation gap to cool the friction members, but without incurring the drawbacks of the known art.

### SUMMARY OF THE INVENTION

According to the present invention, there is provided a railway vehicle disk brake pad with the essential characteristics indicated in claim 1, and the preferred and/or auxiliary characteristics indicated in claims 2-4.

### BRIEF DESCRIPTION OF THE DRAWINGS

A non-limiting embodiment of the present invention will be described, purely by way of example, with reference to the attached drawings, in which:

FIG. 1 shows a plan view of a base plate of the pad according to the present invention;

FIG. 2 shows a section along line II-II of the FIG. 1 base plate;

FIG. 3 shows a partly see-through plan view of the pad according to the present invention;

FIG. 4 shows a cross section along line IV-IV in FIG. 3.

### DETAILED DESCRIPTION OF THE INVENTION

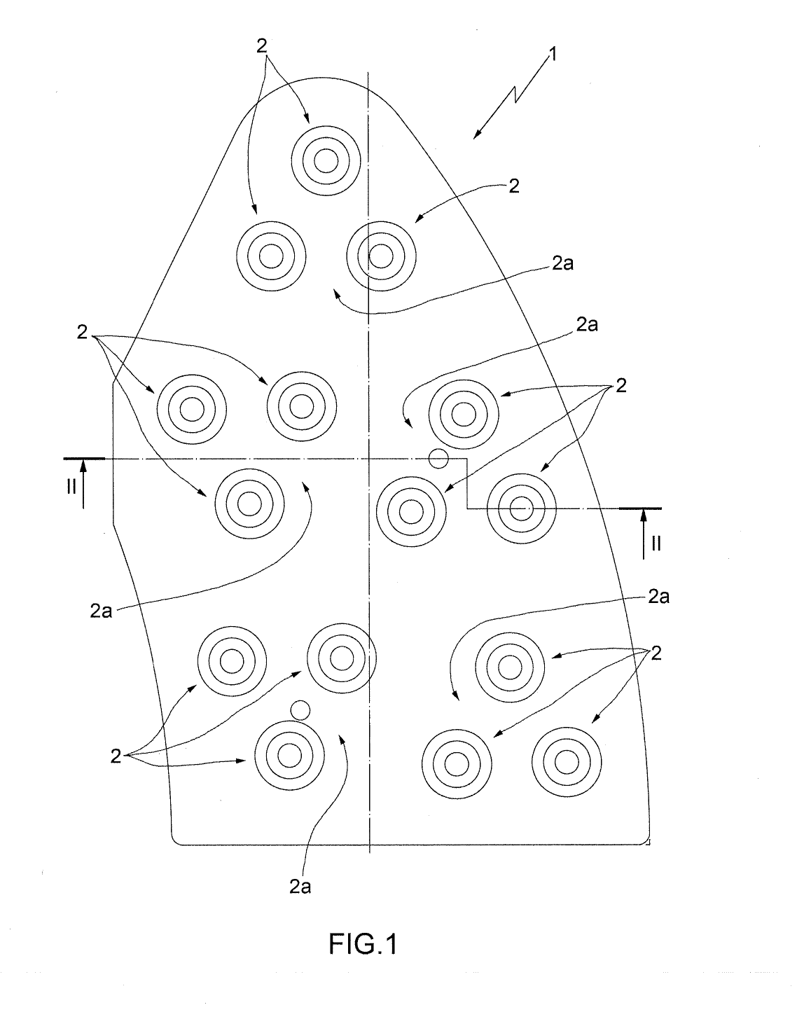

Number 1 in FIG. 1 indicates as a whole a base plate of the disk brake pad according to the present invention.

Base plate 1 comprises a number of circular perforated drawing portions 2 arranged in groups 2a, each comprising three perforated drawing portions 2 arranged in the form of a triangle.

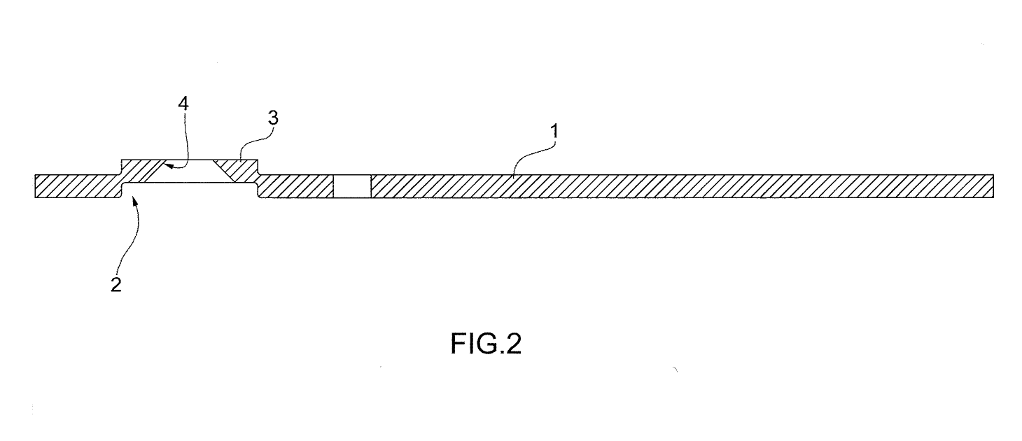

As shown more clearly in FIG. 2, each perforated drawing portion 2 comprises a circular projection 3 with a centre hole 4 defined by a truncated-cone-shaped wall. In actual use, hole 4 is engaged by a rivet for securing a supporting plate to base plate 1, as described below.

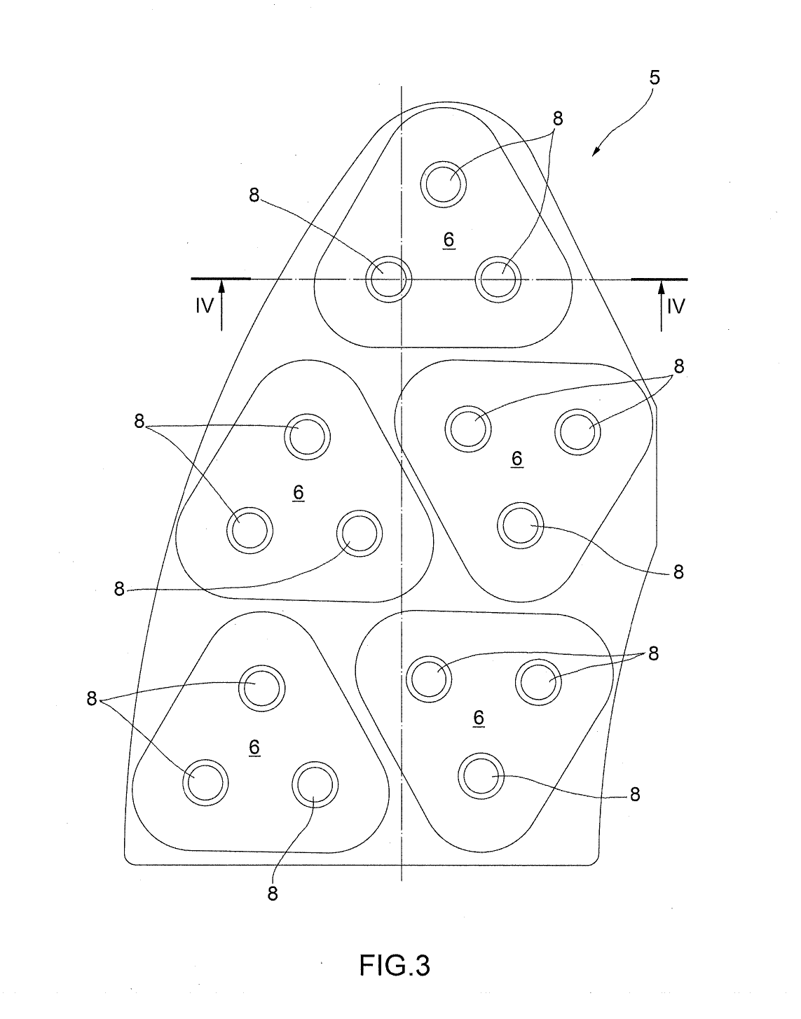

Number 5 in FIG. 3 indicates as a whole a railway vehicle disk brake pad in accordance with the present invention.

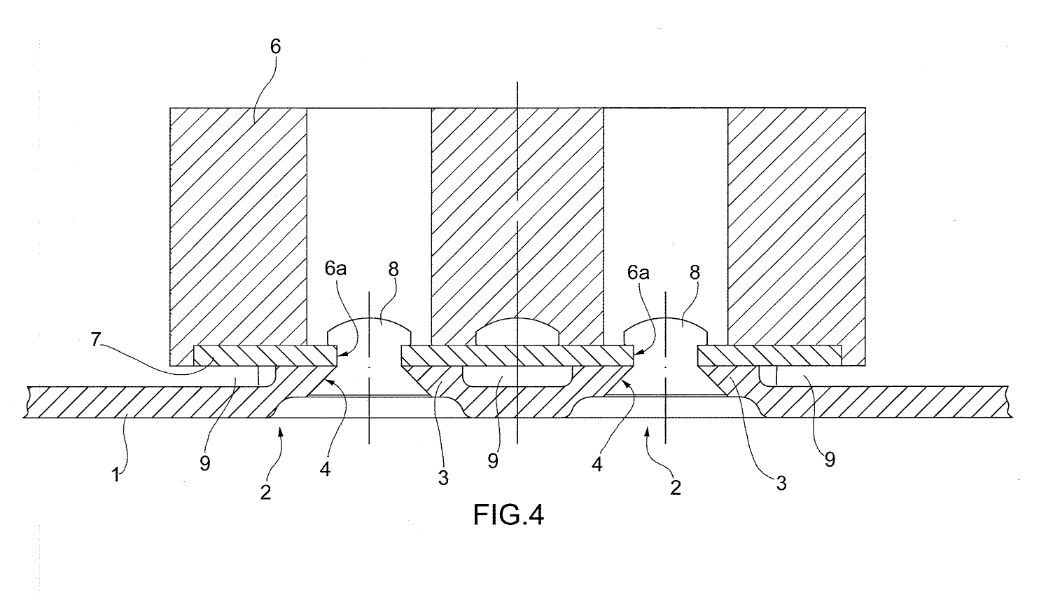

Pad 5 comprises base plate 1; five triangular friction members 6, each fixed to a respective supporting plate 7 (shown in FIG. 4); and a number of rivets 8 for securing supporting plates 7 to base plate 1. More specifically, each supporting plate 7 is fixed to base plate 1 by three rivets 8 arranged in the form of a triangle.

As shown in FIG. 4, to fix each supporting plate to the base plate, each rivet 8 engages both centre hole 4 in the respective perforated drawing portion 2, and a hole 6a formed in supporting plate 7. Obviously, each supporting plate 7 has three holes 6a arranged in he form of a triangle.

Once pad 5 is assembled, rivets 8 fix the relative supporting plates 7 directly contacting circular projections 3 of perforated drawing portions 2. In other words, circular projections 3 support supporting plates 7 detached from the rest of the surface of base plate 1, thus forming a gap 9, between base plate 1 and each supporting plate 7, in which to ventilate and effectively cool friction members 6.

With respect to the solution in Patent DE10043528, the solution according to the present invention provides for reducing the weight of the pad as a whole, thus reducing wear on the seals and the noise level. In this connection, it is important to note how the pad according to the present invention allows the use of shorter rivets, thus reducing overall weight.

Moreover, the number of component parts for assembly is also reduced, with obvious advantages in terms of output and cost.

Finally, the pad according to the present invention is more flexible, thus improving friction and, hence, braking efficiency.

1. A railway vehicle disk brake pad, comprising a base plate; a number of supporting plates fitted to the base plate; and a number of friction members fixed to said supporting plates; wherein said base plate comprises a number of perforated drawing portions, each of which comprises a projection on which a respective supporting plate rests directly, thus forming a gap between the base plate and the supporting plate; each said projection having a centre hole engaged by a respective rivet for securing the respective supporting plate to the base plate.

2. A disk brake pad as claimed in claim 1, wherein each supporting plate is fixed to the base plate by connection to three projections of respective perforated drawing portions arranged in the form of a triangle.

3. A disk brake pad as claimed in claim 2, wherien each friction member is triangular in shape.

4. A disk brake pad as claimed in claim 1, wherien in plan form, each said projection is circular.
